(19) United States
(12) Patent Application Publication
(10) Pub. No.: US 2026/0217941 A1
(43) Pub. Date: Jul. 30, 2026

(54) RECYCLATE POLYOL DISPERSION WITH IMPROVED PHASE STABILITY

(71) Applicants: DOW GLOBAL TECHNOLOGIES LLC, Midland, MI (US); DOW SILICONES CORPORATION, Midland, MI (US); ROHM AND HAAS COMPANY, Collegeville, PA (US)

(72) Inventors: En WANG, Midland, MI (US); Craig F. GORIN, Auburn, MI (US); Hari KATEPALLI, Midland, MI (US); Kaoru AOU, Lake Jackson, TX (US); Jillian EMERSON, Midland, MI (US); Thomas H. KALANTAR, Midland, MI (US); Amy L. REDER, Midland, MI (US); Hans KRAMER, Terneuzen (NL); Paul MWASAME, Collegeville, PA (US); Daniel L. DERMODY, Midland, MI (US)

(21) Appl. No.: 19/142,088

(22) PCT Filed: Dec. 18, 2023
(86) PCT No.: PCT/US2023/084602

§ 371 Date: Jun. 20, 2025

Related U.S. Application Data
(60) Provisional application No. 63/434,518, filed on Dec. 22, 2022.

(51) Int. Cl. C08J 11/22; C08J 3/22; C08K 9/06

(52) U.S. Cl. CPC C08J 11/22; C08J 3/226; C08K 9/06; C08J 2371/02; C08J 2375/12; C08K 2201/006

(57) ABSTRACT

Recyclate polyol dispersions that have a dispersed solid phase are stabilized against settling by the addition of a fumed silica having a certain methanol wettability. The stabilized dispersions are more resistant to particle settling upon standing. The stabilized dispersions are useful for making polyurethanes of various types, including flexible and rigid types of polyurethane foams. The fumed silica has no significant adverse effect on foam production. A stabilized dispersion comprises: A) a recyclate polyol dispersion; and B) 0.1 to 3% by weight, based on the combined weights of components A) and B), of fumed silica particles dispersed in component A). The fumed silica particles have a methanol wettability of 10% to 60% and a BET surface area of 75 m²/g to 500 m²/g. Associated methods are also provided.

Polyurethane foams are made in vast quantities around the globe, with large amounts being used in seating, bedding and other cushioning applications. Much of this foam eventually becomes landfilled or otherwise must be disposed of at the end of the product life cycle. In addition, large quantities of foam waste are generated during the foam production process and subsequent fabrication of the foams. That waste must also be disposed of if it cannot be re-used.

Chemolysis processes for decomposing polyurethanes into useful polyol products are well-known. These represent a potential route to avoid landfilling large quantities of post-consumer and waste polyurethane foam. These chemolysis processes often include a so-called “glycolysis” reaction in which the polyurethane is reacted with a liquid “virgin” polyol at high temperatures. This process breaks urethane and urea linkages in the polyurethane polymer structure to produce a dispersion having a liquid polyol phase and a disperse phase that includes solid oligomeric decomposition products in the form of small particles. The polyol phase typically contains the virgin polyol and liquid “recyclate” polyols, i.e., liquid polyols that are products of the decomposition reactions. Other chemolysis processes include hydrolysis and acidolysis, in which water and carboxylic acids (or, equivalently, carboxylic acid anhydrides) are used as reagents. Frequently, the chemolysis process includes glycolysis together with hydrolysis and/or acidolysis, which can be done simultaneously, sequentially, or partially simultaneously and partially sequentially.

Dispersions produced in these chemolysis processes have been shown to be useful in making both rigid and flexible polyurethane foams.

A problem with these dispersions is they tend to be unstable, in that over time the dispersed solids tend to settle in storage and transportation equipment, and even in the lines and mixhead of foam production equipment. This leads to various problems, such as inconsistencies in the composition of the dispersions, inconsistencies in foam products made using the dispersions, and fouled equipment. A way to stabilize the dispersions to reduce settling is desired. Such a solution preferably does not interfere with a polyurethane foaming process that makes use of the dispersion, and also preferably does not lead to a significant increase in the viscosity of the dispersion.

This invention is in one aspect a stabilized dispersion comprising a mixture of
A) a recyclate polyol dispersion and
B) 0.1 to 3% by weight, based on the combined weights of A and B, of fumed silica particles dispersed in component A), the fumed silica particles having a methanol wettability of 10% to 60% and a BET surface area of 75 m²/g to 500 m²/g.

The stabilized dispersion has the desirable characteristics of improved dispersion stability, i.e., reduced settling of the disperse phase, and viscosities that are not significantly higher than (and sometimes even lower than) those of the recyclate polyol dispersions by themselves.

The invention is also a method for stabilizing a recyclate polyol dispersion, comprising combining the recyclate polyol dispersion with fumed silica particles, the fumed silica particles having a methanol wettability of 10% to 60% and a BET surface area of 75 m²/g to 500 m²/g, to produce a stabilized recyclate polyol dispersion containing 0.1 to 3% by weight of the fumed silica particles based on the combined weights of the recyclate polyol dispersion and the fumed silica particles.

In a third aspect, the invention is a method for making a stabilized recyclate polyol dispersion, comprising
a) in one or more steps, combining a polyurethane and/or polyurethane-urea with virgin polyol and one or more of (i) an imide precursor, (ii) a glycidyl ether and (iii) an alkylene carbonate to form a mixture and subjecting the mixture to chemolysis conditions to produce a recyclate polyol dispersion having i) a liquid phase that comprises recyclate polyol formed by chemolysis of the polyurethane and/or polyurethane-urea and ii) dispersed in the liquid phase, solid particles containing one or more urethane, urea and/or imide groups formed by chemolysis of the solid polyurethane and/or polyurethane-urea and
b) combining the recyclate polyol dispersion produced in step a) with fumed silica particles, the fumed silica particles having a methanol wettability of 10% to 60% and a BET surface area of 75 m²/g to 500 m²/g, to disperse the fumed silica within the recyclate polyol dispersion and produce a stabilized recyclate polyol dispersion containing 0.1 to 3% by weight of the fumed silica particles based on the combined weights of the recyclate polyol dispersion formed in step a) and the fumed silica particles.

As used herein, a “recyclate polyol dispersion” is a mixture of (i) liquid polyols and (ii) dispersed particles containing one or more urethane, urea and/or imide groups, that is produced in the chemolytic decomposition of a polyurethane and/or polyurea polymer. The liquid polyols include polyols regenerated from the polyurethane and/or polyurea polymer in the chemolysis reaction (“recyclate polyols”), and usually further “virgin” polyols that are added into the chemolysis process. “Virgin” polyols are polyols added into the chemolysis process, and do not include the polyurethane and/or polyurea polymers or polyols produced by the chemolysis thereof. The dispersed particles containing one or more of urethane, urea and/or imide groups are also materials generated in the chemolysis of the polyurethane and/or polyurea polymer.

The liquid polyols may constitute, for example, 10 to 100%, especially 20 to 60% by weight of recyclate polyols and correspondingly 0 to 90%, especially 40 to 80% by weight virgin polyols. The liquid polyols may include, for example a virgin polyether polyol having a number average molecular weight of 400 to 16,000 g/mol, especially 400 to 4,000 g/mol (by gel permeation chromatography against polystyrene standards) and a hydroxyl functionality of 2 to 8, 2 to 6 or 2 to 4. The recyclate polyol also may include one or more polyether polyols.

Alternatively or in addition, the liquid polyols may include short-chain diols and/or triols having formula molecular weights of up to 250 or up to 150, including, for example, one or more of ethylene glycol, diethylene glycol, propylene glycol, dipropylene glycol, glycerin, trimethylolpropane, triethylolpropane and the like. The short-chain diols and/or triols may include both virgin materials and diols and/or triols formed in the chemolysis reaction.

The dispersed particles may constitute, for example, 1 to 60%, preferably 5 to 60% or 10 to 50% of the total weight of the recyclate polyol dispersion. In some embodiments, at least a portion of the dispersed particles include imide groups. Imide groups can be formed, for example, by including an imide precursor as described more fully below in the chemolysis process. The dispersed particles typically have primary particle sizes (D90) less than 5 μm, preferably less than 1 μm, as determined by microscopy. Agglomerated particles may have somewhat larger D90 particle sizes, such as up to 50 μm. The dispersed particles are insoluble in the liquid polyols and are not grafted or otherwise chemically bonded to the liquid polyols.

The recyclate polyol dispersion in some embodiments has a hydroxyl number (per ASTM D4274 D) of 20 to 650 mg KOH/g, especially 25 to 500 mg KOH/g; a total basicity (ASTM D6979) of 1 milliequivalent per gram or lower, especially 0.5 milliequivalent per gram or lower; and an acid number (DIN53402) of 20 mg KOH/g or lower, especially 5 mg KOH/g or lower.

By “chemolysis” or “chemolytic decomposition”, it is meant a decomposition of a polyurethane and/or polyurea polymer by chemical means. Included within “chemolysis” are so-called “glycolysis”, wherein a polyol is reacted with the polyurethane and/or polyurea polymer to decompose the polymer; hydrolysis, wherein water is a reagent that decomposes the polymer; acidolysis, wherein a Bronsted acid, particularly a diacid (or, equivalently a carboxylic acid anhydride) is used as a decomposition agent, and aminolysis, wherein a primary or secondary amine compound is a decomposition agent. A chemolysis may include more than one of these decomposition methods. For example, glycolysis and acidolysis, glycolysis and hydrolysis, glycolysis and aminolysis, glycolysis, acidolysis and hydrolysis or even glycolysis, acidolysis, aminolysis and hydrolysis may be performed on the polyurethane and/or polyurea polymer to produce the recyclate polyol dispersion.

Chemolysis processes for producing recyclate polyol dispersions are well-known. An alcoholysis (sometimes referred to as “glycolysis”) process is described, for example, in U.S. Pat. No. 2,937,151. An acidolysis process is described in U.S. Pat. No. 3,109,824. An aminolysis process is described in U.S. Pat. No. 3,404,103. Any of these processes are suitable for producing a recyclate polyol dispersion for use in this invention.

Other suitable chemolysis processes include those described in U.S. Pat. No. 5,357,006, wherein a monofunctional glycidyl ether is added into a glycolysis process to reduce the amine number of the recyclate polyol dispersion, and in U.S. Pat. No. 5,763,692, wherein a cyclic carbonate is added into the glycolysis process to the same effect. It is believed the monofunctional glycidyl ether and cyclic carbonate react with amine groups on the dispersed particles produced by the glycolytic decomposition to “cap” the chain ends.

An especially preferred chemolysis process is a glycolysis/acidolysis process in which the polyurethane and/or polyurea polymer is reacted with both a polyol and an imide precursor to produce the recyclate polyol dispersion. An example of such a process is described in U.S. Pat. No. 11,124,623. In that process, a polyurethane and/or polyurea polymer is reacted with an imide precursor and a polyether polyol having a number average molecular weight of 400 to 6000 g/mol and a hydroxyl functionality of 2 to 4 in a first reaction step, and then with a short-chain diol or triol in a second reaction step to produce the recyclate polyol dispersion. An “imide precursor” is a material that reacts during the chemolysis process to produce imide groups on the dispersed solid particles that are produced in the chemolysis reaction, generally through reaction with primary amino groups. Imide precursors include compounds having two or more carboxyl groups, wherein at least one pair of carboxyl groups are in the 1,2-positions relative to each other, as well as the corresponding carboxylic acid anhydrides. The imide precursor may be, for example, maleic acid, malic acid, phthalic acid, adipic acid, succinic acid, glutaric acid, di- and/or tetrahalogenated phthalic acid, trimellitic acid, and any one or more of their corresponding anhydrides. Imide-containing particles are produced in this process. Reaction temperatures are in the range of 170 to 210° C. in the first step and 180 to 230° C. in the second step. The glycolysis/acidolysis is catalyzed using a free radical initiator such as a peroxide compound, perester compound, or azo compound.

The starting polyurethane and/or polyurea polymer is characterized by having urethane groups, urea groups, or both urethane and urea groups. It may contain other groups formed by reactions of isocyanates, such as biuret, carbodiimide, allophonate, isocyanurate and the like. A preferred polyurethane and/or polyurea polymer includes polyether chains, especially chains of homopolymerized 1,2-propylene oxide, homopolymerized ethylene oxide, homopolymerized 1,2- and/or 2,3-butylene oxide, homopolymerized tetrahydrofuran or copolymers (random and/or block, for examples) of any two or more of ethylene oxide, 1,2-propylene oxide, 1,2- or 2,3-butylene oxide and tetrahydrofuran. The polyurethane and/or polyurea polymer may be non-cellular, microcellular, or cellular.

Preferably, the polyurethane and/or polyurea polymer is or includes post-consumer waste and/or scrap polyurethane, such as scrap from a polyurethane foam manufacturing facility or a facility that fabricates polyurethane foam into consumer products. Most preferably the polyurethane and/or polyurea polymer is or includes post-consumer or scrap flexible polyurethane foam. Discarded mattresses are an abundant source of post-consumer flexible polyurethane foam for use in producing the recyclate polyol dispersion. Typically, the polyurethane and/or polyurea polymer is cut into small pieces for chemolysis.

The recyclate polyol dispersion is stabilized by combining it with fumed silica particles. The fumed silica particles are characterized in having a methanol wettability of 10% to 60%, preferably 30 to 60%, and a BET surface area of 75 m²/g to 500 m²/g, preferably 90 m²/g to 300 m²/g.

Methanol wettability is measured by weighing 0.2 g fumed silica and adding it into 20 g deionized water, followed by stirring on a high-speed laboratory mixer for 1 minute. The mixture is then examined visually to see whether the fumed silica is dispersed homogeneously in the liquid. If so, methanol wettability is 0. If not, methanol is added in increments, increasing the proportion of methanol in the methanol/water mixture by 5 weight-% with each increment (i.e., to 5/95, 10/90, 15/85, etc.). After each increment of methanol is added, the mixture again is stirred on the high-speed laboratory mixer for 1 minute, followed by visual examination for homogeneity. The lowest weight percentage of methanol that produces a homogeneous dispersion on this test is the methanol wettability value.

BET surface area is measured according to ASTM D5604-21 or equivalent method.

The fumed silica particles preferably are surface-modified to attain the requisite methanol wettability. Surface modification can be achieved by applying one or more of an organosilane and an organodisilazane to the surface of the fumed silica particles. The organosilane or organodisilazane may be one or more of a dialkyldichlorosilane wherein the alkyl groups each contain 1 to 12 carbon atoms, a C₁₋₁₂ alkyl trialkoxysilane wherein the alkoxy groups each contains 1-4 carbon atoms, and a hexaalkyldisilazane where the alkyl groups each contain 1 to 12 carbon atoms. Specific examples of the organosilane or organodisilazane include dimethyldichlorosilane, diethyldichlorosilane, hexyltrimethoxysilane, octyltrimethoxysilane, decyltrimethoxysilane, dodecyltriethoxysilane, hexyltriethoxysilane, octyltriethoxysilane, decyltriethoxysilane, dodecyltriethoxysilane, hexamethyldisilazane and hexaethyledisilazane.

Commercially available fumed silica products useful in this invention include Aerosil® R974, Aerosil® R805, Aerosil® R972 and Aerosil® R812 fumed silicas, all from Evonik Industries AG.

Enough fumed silica is combined with the recyclate polyol dispersion to provide the resulting stabilized dispersion with 0.1 to 3% by weight of the fumed silica particles. based on the combined weights of the recyclate polyol dispersion and the fumed silica particles. The weight of the fumed silica particles includes the weight of any surface modification. Smaller quantities provide little stabilization effect (as expressed by Instability Index as described more fully below) and larger amounts tend to lead to increased viscosities with little additional benefit in stabilization. A preferred lower amount of fumed silica is at least 0.25% or at least 0.5% on the same basis. A preferred upper amount of fumed silica is 2.5% or 2%, again on the same basis.

The combining step can be performed by dispersive mixing at any convenient temperature, such as from 0° C. to 230° C. It is typically necessary to perform the mixing under dispersive conditions to disperse the fumed silica into the recyclate polyol dispersion. Useful dispersive mixers include rotor/stator types as are sold by Silverson Machines, Ltd. (Chesham, England); centrifugal mixers such as FlackTek Speedmixers (FlackTek, Landrum SC, USA), sonic and ultrasonic mixers such as Sonolator® (Sonic Corporation, Stratford CT, USA) and the UIP series of ultrasonicators sold by Hielscher Ultrasonics GmbH (Teltow, Germany), milling devices such as bead mills (as described in WO2004/020532) and the like are useful, Temperatures at or around room temperature, such as from 15° C. to 35° C., are entirely suitable. Mixing is continued until the fumed silica becomes homogeneously dispersed within the recyclate polyol dispersion. This typically can be performed with 30 minutes mixing or less, although longer mix times can be used if desired.

The combining step may be performed by producing a masterbatch of the fumed silica in virgin polyol and letting the masterbatch down into the recyclate polyol dispersion. Such a masterbatch may have a fumed silica content of, for example, 3 to 35% by weight. The masterbatch preferably is produced using dispersive mixing as described above; the let-down step in such cases often can be performed under simple mixing conditions, although dispersive mixing methods can be used in the let-down step as well.

The resulting stabilized recyclate polyol dispersion is characterized in being more stable than the starting dispersion. “Stability” in this context refers to stability against particle settling; a more stable dispersion exhibits less particle settling than the starting dispersion when maintained under equivalent conditions.

Stability is conveniently expressed by an “Instability Index”, wherein lower Instability Index values indicate greater stability, i.e., less particle settling. Instability Index is determined according to ISO 13318-2 (2007) or equivalent method. Instability Index can be determined using a LUMiSizer 6110-77 instrument (LUM GmbH) by centrifuging the material for 5 hours at a rate of 4000 rpm. A software package supplied by the same vendor (SEPView Explorer, LUM GmbH) can be used to calculate Instability Index.

The Instability Index of the stabilized recyclate polyol dispersion may be, for example, 40-99% lower than that of the starting recyclate polyol dispersion (i.e., before combination with the fumed silica). In absolute terms, the Instability Index is preferably no greater than 0.050 or no greater than 0.040. For example, the Instability Index of the stabilized recyclate polyol dispersion may be 0.001 to 0.050, 0.0025 to 0.050 or 0.0025 to 0.040.

An advantage of the invention is that significant reduction in Instability Index is achieved without significant increase in viscosity. Preferably, the viscosity of the stabilized recyclate polyol dispersion is no greater than twice that of the starting recyclate polyol dispersion, when measured using a 25 mm parallel plate rheometer with a gap of 1.2 mm at 25° C. and a shear rate of 0.1 sec⁻¹. More preferably, the viscosity of the stabilized recyclate polyol dispersion is no more than 1.5 times, or no more than 1.25 times, that of the starting dispersion. In absolute terms, the viscosity in some embodiments as measured under the aforementioned conditions is no greater than 35 Pa·s, no more than 30 Pa·s, no more than 25 Pa·s, no more than 22.5 Pa·s or no more than 20 Pa·s.

The stabilized polyol dispersion is useful for making polyurethanes of various types, in particular rigid, semi-rigid, and/or flexible polyurethane foams, by reaction with a polyisocyanate. In general, the stabilized polyol dispersion and polyisocyanate are combined to form a reaction mixture that is then cured to form the polyurethane. Curing is typically spontaneous, even when the stabilized polyol dispersion and polyisocyanate are combined at about room temperature. However, catalysts and/or elevated curing temperatures may be used to adjust the curing rate if desired. Curing may be performed in a mold; polyurethane foam can be made if desired in a free-rise process in which the foam formulation is dispensed into an open trough or box and allowed to rise without vertical constraint. Various other ingredients may be present in the reaction mixture, including, for example:
A) additional polyols, such as polyether and/or polyester polyols, having hydroxyl numbers of 375 mg KOH/g or less and 1 to 8 hydroxyl groups per molecule;
B) short-chain polyols having 2 to 4 hydroxyl groups per molecule and hydroxyl numbers of 376 to 1870;
C) amino alcohols such as diethanolamine, monoethanolamine and triethanolamine;
D) amine-terminated polyethers;
E) blowing agents, including chemical blowing agents such as water and physical blowing agents of various kinds;
F) catalysts, including catalysts for the reaction of an isocyanate group with an alcohol, catalysts for the reaction of an isocyanate group with water, and isocyanate trimerization catalysts;
G) surfactants, including foam-stabilizing surfactants as are useful for making polyurethane foam;
H) colorants, fillers, and other particulates;
I) reinforcing fibers;
J) preservatives such as biocides, fungicides, antioxidants;
K) “cool touch” additives such as an encapsulated phase change material; as well as other additives as may be useful for making polyurethanes of various types.

Suitable methods for making polyurethanes of various types are described, for example, in U.S. Pat. Nos. 3,632,707, 4,350,778, 7,704,410, 4,970,243, 5,157,056, 5,582,840 and 6,005,016, and U.S. Published Patent Application No. 2020/0040153, among many others. In general, the stabilized polyol dispersion of the invention may be used in the same general manner as conventional polyols of similar hydroxyl functionality and equivalent weight.

In the following examples, all parts and percentages are by weight unless otherwise indicated.

The fumed silicas used in the following examples are as follows:

| | | Surface Area, | Methanol |
|---|---|---|---|
| Designation | Modifier | m²/g* | Wettability, % |
| FS-1 | Dimethyldichlorosilane | 150-190 | 30 |
| FS-2 | Octyltrimethoxysilane | 125-175 | 50 |
| FS-3 | Dimethyldichlorosilane | 90-130 | 40 |
| FS-4 | Hexamethyldisilazane | 230-290 | 60 |
| FS-5 | Hexamethyldisilazane | 190-245 | 60 |
| FS-A | None | 200 | 0 |
| FS-B | Hexadecylsilane | 170-210 | 0 |
| FS-C | Methacrylsilane | 125-175 | 5 |
| FS-D | Polydimethylsiloxane | 80-120 | 65 |
| FS-E | Polydimethylsiloxane | 80-140 | 65 |

*BET surface areas as reported by the manufacturer.

The recyclate polyol dispersion (RPD) used in the following examples is a dispersion produced by chemolysis (glycolysis and acidolysis) of polyurethane foam scrap according to the general method described in U.S. Pat. No. 11,224,623. The RPD has a liquid polyol phase that includes virgin polyol and a recyclate polyol produced by chemolysis of the polyurethane foam scrap, and dispersed solid particles having D90 primary particle sizes of less than 5 μm, with agglomerates having a D90 particle size of 50 μm. The dispersed particles are produced by chemolysis of the polyurethane foam scrap and contain imide groups as well as urethane and/or urea groups. The dispersed particles constitute 14% of the total weight of the RPD. The RPD has a hydroxyl number of 60 mg KOH/g, a total basicity of 0.243 milliequivalents per gram, an acid number of 1.27 mg KOH/g, and a water content of 0.08% by weight. The viscosity of the RPD as measured using a 25 mm parallel plate rheometer with a gap of 1.2 mm at 25° C. is 15.75 Pa·s at a shear rate of 0.1 sec⁻¹ and 4.74 Pa·s at a shear rate of 100 sec⁻¹.

For each of Examples 1-5, 1A and Comparative Samples A-I, the RPD is blended with a fumed silica of the type and amount indicated in Table 1. Blending is done for 1-2 minutes at room temperature using a FlackTek Speedmixer® laboratory mixture at 3000 rpm for 1 minute, until the blended material becomes visually homogeneous.

In each case, viscosity is measured in the same manner described with regard to the RPD, at shear rates of 0.1 sec⁻¹ and 100 sec⁻¹. “Instability Index” is measured according to ISO 13318-2 (2007) using a LUMiSizer 6110-77 instrument (LUM GmbH) by centrifuging the material for 5 hours at a rate of 4000 rpm. A transmission profile is recorded over time and the recorded data is processed using SEPView Explorer package (LUM GmbH) to calculate Instability Index. Results are as indicated in Table 1.

TABLE 1

| | FS | | | | | Viscosity, | |
|---|---|---|---|---|---|---|---|
| | | | Surface | MeOH | Insta- | Pa · s | |
| Desig- | | | Area, | Wettability, | bility | 0.1 | 100 |
| nation | Type | Amount | m²/g | % | Index | sec⁻¹ | sec⁻¹ |
| A* | None | | | | 0.083 | 15.75 | 4.74 |
| B* | FS-A | 1% | 200 | 0 | 0.05 | 43.49 | 5.31 |
| C* | FS-A | 3% | 200 | 0 | 0.005 | 302.6 | 7.42 |
| D* | FS-B | 1% | 170-210 | 0 | 0.053 | 41.98 | 5.06 |
| E* | FS-B | 3% | 170-210 | 0 | 0.012 | 235.9 | 6.85 |
| F* | FS-C | 1% | 125-175 | 5 | 0.057 | 31.04 | 5.17 |
| G* | FS-C | 3% | 127-175 | 5 | 0.005 | 76.85 | 6.51 |
| 1 | FS-1 | 1% | 150-190 | 30 | 0.038 | 21.24 | 5.24 |
| 1-A | FS-1 | 3% | 150-190 | 30 | 0.005 | 30.02 | 7.11 |
| 2 | FS-2 | 1% | 125-175 | 50 | 0.039 | 20.95 | 4.77 |
| 3 | FS-3 | 1% | 90-130 | 40 | 0.050 | 15.23 | 4.6 |
| 4 | FS-4 | 1% | 230-290 | 60 | 0.025 | 11.62 | 4.62 |
| 5 | FS-5 | 1% | 195-245 | 60 | 0.032 | 11.89 | 4.99 |
| H* | FS-D | 1% | 80-120 | 65 | 0.077 | 41.59 | 4.81 |
| I* | FS-E | 1% | 80-140 | 65 | 0.074 | 50.78 | 5.24 |

*Not an example of the invention. Surface areas as reported by manufacturer.

Comp. Sample A contains no fumed silica. It has the highest instability index of the tested samples, indicating the poorest stability.

Comparative Samples B-G all contain a fumed silica with a low methanol wettability. These all result in some reduction of the instability index, indicating better stabilization, but all exhibit a very sharp increase in viscosity at low shear rates (0.1 sec-1). Among Comparative Samples B-G, Comparative Samples Cand G exhibit the greatest improvement in stabilization (0.005 Instability Index) but their viscosities are 5 to almost 20 times greater than that of the recyclate polyol dispersion by itself.

Comparative Samples H and I each contain a fumed silica with a high methanol wettability. These provide for only a minimal improvement in stability at the cost of large viscosity increases.

Examples 1-5 and 1A demonstrate that significant stability improvements can be achieved without large viscosity increases when a fumed silica having a methanol wettability of 30 to 60 is selected. At the same additive levels, FS-1 to FS-5 all improve stability as well or better than FM-A to FM-C, with the clear advantage of a much lower increase in viscosity (and in some cases even a decrease in viscosity).

Polyurethane foams are made by combining the ingredients listed in Table 2 at about 23° C. to produce a reaction mixture. The Polyether Triol is a random copolymer of 89% 1,2-propylene oxide and ethylene oxide. All ingredients except the stannous octoate and toluene diisocyanate (TDI, 80% 2,4-isomer) are combined first, followed by the stannous octoate and then the toluene diisocyanate. The resulting reaction mixture is poured into an open box mold and allowed to cure until tack-free. The foam is then post-cured in a 140° C. oven for 5 minutes, removed from the mold and then aged aging overnight at 20-25° C.

Foam properties are measured according to ASTM D3574-17 or equivalent. Results are as indicated in Table 2.

TABLE 2

| | Parts By Weight | | |
|---|---|---|---|
| Ingredients | Comp. Foam A* | Foam 1 | Foam 2 |
| 3500 M_{w} Polyether triol | 79 | 79 | 79 |
| RPD | 21 | 21 | 21 |
| Amine Catalyst Mixture | 0.15 | 0.15 | 0.15 |
| Silicone Surfactant | 0.6 | 0.6 | 0.6 |
| FS-1 | 0 | 0 | 0.25 |
| FS-4 | 0 | 0.25 | 0 |
| Stannous Octoate | 0.11 | 0.11 | 0.11 |
| Water | 3.8 | 3.8 | 3.8 |
| TDI (index) | 104 | 104 | 104 |
| Properties | | | |
| Density, kg/m³ | 28.2 | 29.0 | 29.5 |
| Compression Force Deflection, kPa | | | |
| 25% | 3.6 | 3.8 | 3.8 |
| 40% | 4.5 | 4.5 | 4.6 |
| 65% | 9.4 | 9.0 | 9.4 |
| Tensile Strength, kPa | 133 | 142 | 135 |
| Resilience, % | 32 | 34 | 36 |
| Air flow, dm³/s | 1.0 | 1.2 | 1.4 |

As shown by the data reported in Table 2, the addition of FS-1 or FS-4 into the foaming process has at most negligible effect on the foaming process and foam properties. A small increase in air flow is seen.

1. A stabilized dispersion comprising:
A) a recyclate polyol dispersion; and
B) 0.1 to 3% by weight, based on the combined weights of components A) and B), of fumed silica particles dispersed in component A);
wherein the fumed silica particles have a methanol wettability of 10% to 60% and a BET surface area of 75 m²/g to 500 m²/g.

2. The stabilized dispersion of claim 1, wherein the recyclate polyol dispersion A) comprises:
A-1) a continuous liquid phase comprising a recyclate polyol produced by chemolysis of a solid polyurethane and/or polyurethane-urea; and
A-2) solid particles having primary D90 particle sizes of 5 μm or less dispersed in component A), wherein the particles are insoluble in component A-1), contain one or more urethane, urea, and/or imide groups, the particles being formed by chemolysis of the solid polyurethane and/or polyurethane-urea.

3. The stabilized dispersion of claim 1, wherein the fumed silica particles have a methanol wettability of 30% to 60%.

4. The stabilized dispersion of claim 1, wherein the fumed silica particles are modified with one or more of an organosilane and/or an organodisilazane.

5. The stabilized dispersion of claim 4, wherein the fumed silica particles are modified with one or more of a dialkyldichlorosilane wherein each alkyl group independently contains 1 to 12 carbon atoms, a C₁₋₁₂ alkyl trialkoxysilane wherein each alkoxy group independently contains 1 to 4 carbon atoms, and a hexaalkyldisilazane wherein each alkyl group independently contains 1 to 12 carbon atoms.

6. The stabilized dispersion of claim 5, wherein the fumed silica particles are modified with one or more of dimethyldichlorosilane, diethyldichlorosilane, hexyltrimethoxysilane, octyltrimethoxysilane, decyltrimethoxysilane, dodecyltriethoxysilane, hexyltriethoxysilane, octyltriethoxysilane, decyltriethoxysilane, dodecyltriethoxysilane, hexamethyldisilazane, and/or hexaethyldisilazane.

7. A method for stabilizing a recyclate polyol dispersion, the method comprising: combining the recyclate polyol dispersion with fumed silica particles, the fumed silica particles having a methanol wettability of 10% to 60% and a BET surface area of 75 m²/g to 500 m²/g, to produce a stabilized recyclate polyol dispersion containing 0.1 to 3% by weight of the fumed silica particles based on the combined weights of the recyclate polyol dispersion and the fumed silica particles.

8. A method for making a stabilized recyclate polyol dispersion, the method comprising:
a) in one or more steps, combining a polyurethane and/or polyurethane-urea with virgin polyol and one or more of (i) an imide precursor, (ii) a glycidyl ether, and (iii) an alkylene carbonate to form a mixture and subjecting the resulting mixture to chemolysis conditions to produce a recyclate polyol dispersion having i) a liquid phase that comprises recyclate polyol formed by chemolysis of the polyurethane and/or polyurethane-urea and ii) dispersed in the liquid phase, solid particles containing one or more urethane, urea, and/or imide groups formed by chemolysis of the solid polyurethane and/or polyurethane-urea; and
b) combining the recyclate polyol dispersion produced in step a) with fumed silica particles, the fumed silica particles having a methanol wettability of 10% to 60% and a BET surface area of at 75 m²/g to 500 m²/g, to disperse the fumed silica within the recyclate polyol dispersion and produce a stabilized recyclate polyol dispersion containing 0.1 to 3% by weight of the fumed silica particles based on the combined weights of the recyclate polyol dispersion formed in step a) and the fumed silica particles.

9. The method of claim 7, wherein the fumed silica particles have a methanol wettability of 30% to 60%.

10. The method of claim 7, wherein the fumed silica particles are modified with one or more of an organosilane and/or an organodisilazane.

11. The method of claim 10, wherein the fumed silica particles are modified with one or more of a dialkyldichlorosilane wherein each alkyl group independently contains 1 to 12 carbon atoms, a C₁₋₁₂ alkyl trialkoxysilane wherein each alkoxy group independently contains 1 to 4 carbon atoms, and a hexaalkyldisilazane wherein each alkyl group independently contains 1 to 12 carbon atoms.

12. The method of claim 11, wherein the fumed silica particles are modified with one or more of dimethyldichlorosilane, diethyldichlorosilane, hexyltrimethoxysilane, octyltrimethoxysilane, decyltrimethoxysilane, dodecyltriethoxysilane, hexyltriethoxysilane, octyltriethoxysilane, decyltriethoxysilane, dodecyltriethoxysilane, hexamethyldisilazane, and/or hexaethyldisilazane.

13. The method of claim 8, wherein step b) is performed under conditions of dispersive mixing.

14. The method of claim 8, wherein step b) is performed by forming a masterbatch containing the fumed silica dispersed in a virgin polyol and letting the masterbatch down into the recyclate polyol dispersion.

15. A stabilized recyclate polyol dispersion made according to the method of claim 7.

16. A stabilized recyclate polyol dispersion made according to the method of claim 8.
